(19) United States
(12) Patent Application Publication
(10) Pub. No.: US 2010/0207301 A1
(43) Pub. Date: Aug. 19, 2010

(54) METHOD OF FORMING FINE CHANNEL USING ELECTROSTATIC ATTRACTION AND METHOD OF FORMING FINE STRUCTURE USING THE SAME

(76) Inventors: Kahp Yang SUH, SEOUL (KR); Pil Nam KIM, SEOUL (KR)

Correspondence Address: IPLA P.A., 3550 WILSHIRE BLVD., 17TH FLOOR, LOS ANGELES, CA, 90010, US

(21) Appl. No.: 12/372,596

(22) Filed: Feb. 17, 2009

(51) Int. Cl. B29C 59/16

(52) U.S. Cl. 264/447

(57) ABSTRACT

A method of forming micro/nano channels and a method of forming micro/nano structures are provided which can easily form micro- and nano-sized channels and structures through simple processes. UV curable polymer patterns are formed on a first substrate, and the UV curable polymer patterns and a second substrate are sealed together by an electrostatic attraction. Then, a channel is formed by irradiating UV light. Also, after reversibly sealing the polymer patterns and a third substrate, prepolymer patterns are formed on the third substrate by flowing prepolymer. Then, the third is removed to form a fine structure. The nano-sized channels as well as the micro-sized channels can be formed through the substantially equal processes. Also, the reversible sealing or the irreversible sealing can be freely selected according to the coating of the curable polymer and UV irradiation time.

### BACKGROUND OF THE INVENTION

1. Field of the Invention

The present invention relates to a method of forming a fine channel using polymer, which can induce an electrostatic attraction, and a method of forming a fine structure using the same, and more particularly, to a method of forming micro/nano channels and a method of forming micro/nano structures using the same, capable of forming structures such as micro/nano-sized channels economically and rapidly and having good biocompatibility.

2. Description of the Related Arts

With the recent advance of micro and nano fluidics for analysis and separation of biomolecules, many processes have been developed which can form micro- or nano-sized channels using soft lithography, e-beam lithography, and nanoimprint lithography, in addition to traditional photolithography. The micro-sized channels can be easily formed using photolithography and soft lithography. However, photolithography is complicated and expensive. In addition, due to the limitation of pattern size, photolithography is unsuitable for patterning line width of 100 nm (1 nm=10⁻⁹ m) or below. To solve these problems of photolithography, so-called ‘soft lithography’ has been developed. (“Polymeric Microstructures Formed by Moulding in Capillaries”, Nature (1995), Kim, E. et al., pp. 581-584, and U.S. Pat. No. 6,355,198.) According to soft lithography, a flexible Poly-DiMethylSiloxane (PDMS) mould is spontaneously brought into conformal contact with a substrate, and a prepolymer flows into an empty space between the mould and the substrate due to capillary force. Then, the prepolymer is cured to form patterns.

When PDMS is used, however, the deficiency of physical properties as an elastomer makes it impossible to duplicate a nano structure of 100 nm or less. That is, PDMS-based soft lithography has difficulty in forming nano-sized channels. Also, soft lithography forms structures by inducing conformal contact using wetting properties and elasticity of the mould itself. That is, soft lithography poses serious limitations in that it must use materials with low mechanical modulus and excellent wetting properties.

The resolution limitation of soft lithography can be resolved by the use of e-beam lithography or nanoimprint lithography. However, since the e-beam lithography employs an anodic bonding or a fusion bonding for bonding channels using a high voltage or high temperature, it is difficult to secure channel stability after the bonding. In addition, since heat resistant materials must be used, material limitation is severe. Moreover, since master patterns formed by photolithography or e-beam lithography are used, the manufacturing efficiency is low and the manufacturing cost is very high.

The nanoimprint lithography is economically unbearable because master patterns formed by the e-beam lithography can be used only one time. Also, a heat bonding method depends on fluidity of polymer above the polymer's glass transition temperature during the process of forming channels. Therefore, the size adjustment is difficult. Further, the above-described methods cannot be applied to various processes because the substrate is made of rigid materials such as silicon or glass.

Meanwhile, when the channels are used for bio material analysis, contamination of channel wall with reagent molecules must be solved. SU-8 channels and glass/PDMS channels have been widely used as the channels.

In the case of SU-8 channels, their surface characteristics are unsuitable for analysis of target samples with high accuracy. This is because biomolecules in a flowing stream within the channel adsorb to the channel wall non-specifically. Also, since the channels are bonded at high voltage and high pressure, chips may be damaged.

In the case of the glass/PDMS channels, since the PDMS has many advantages such as flexibility, low cost, transparency, the glass/PDMS channels have been used as channels of biological diagnosis or analysis systems. However, since the channels are bonded by modifying their surfaces using plasma, the durability or channel stability is poor. Also, since the glass/PDMS channels have hydrophobic surfaces, non-selective adsorption of biological species such as cells and proteins within the channels is caused when the glass/PDMS channels are used for a long time. Consequently, the channels are clogged or damaged. Most of all, the above-described methods have problems in that nano-sized channels cannot be formed due to limitations of pattern size.

To prevent non-selective adsorption of biomolecules within the conventional micro channels, a variety of methods have been proposed. As one example, inner surfaces of channels are modified using materials that can prevent non-selective adsorption of biomolecules such as Poly Ethylene Glycol (PEG). This technology was set forth as a self-assembled monolayer. (M. B. Stark, K. Hlmberg, Biotechnol. Bioeng. 1989, 34, 942, and Jon, S. Y.; Seong, J. H.; Khademhosseini, A.; Tran, T. N. T.; Laibinis, P. E.; Langer, R. Langmuir 2003, 19, 9989-9993). This technology will be briefly described below.

First, glass substrate is bonded to a PDMS micro channel. To inhibit inner surfaces of the channels from reacting with biomolecules, a solution dissolved with PEG polymer is flowed into the channels. Then, properties of the glass or PDMS channels are changed. According to this technology, however, it is difficult to continuously maintain the surfaces to have the desired properties. Also, the solution flowing into the channels may cause a secondary pollution. Moreover, this technology is hard to apply to nano-sized channels and the processes are complicated and difficult.

As another method for improving the inner surface properties of the channels, some material that can improve the quality of a PDMS is mixed and channels are then formed. This method can prevent non-selective adsorption of biomolecules compared with channels whose surfaces are not modified, but its efficiency is relatively low and its process is complicated. In addition, all of the existing nano channels cause non-selective adsorption by biological species.

### SUMMARY OF THE INVENTION

An object of the present invention is to provide a method of forming micro/nano channels using an electrostatic attraction, capable of easily adjusting the size of patterns up to nanometer and preventing non-selective adsorption by biomolecules.

Another object of the present invention is to provide a method of micro/nano structure using the method of forming micro/nano channels.

According to an aspect of the present invention, there is provided a method of forming a fine, irreversibly sealed channel using an electrostatic attraction, including: forming UV curable polymer patterns on a first substrate; sealing the UV curable polymer patterns and a second substrate by an electrostatic attraction, the second substrate including a UV curable polymer layer formed thereon; and forming a channel by irradiating UV light such that UV curable polymer patterns and the UV curable polymer layer sealed together are cross-linked by polymerization.

According to another aspect of the present invention, there is provided a method of forming a fine structure using an electrostatic attraction, including: forming UV curable polymer patterns on a first substrate; contacting the UV curable polymer patterns with a third substrate to reversibly seal the UV curable polymer patterns and the third substrate by an electrostatic attraction on; irradiating UV light on the UV curable polymer patterns reversibly sealed with the third substrate; forming prepolymer patterns on the third substrate by flowing prepolymer between the third substrate and the polymer patterns to which the UV light is irradiated; curing the prepolymer patterns by irradiating UV light thereon; and removing the first substrate with the UV curable polymer patterns from the third substrate with the cured prepolymer patterns.

According to the present invention, any material that can generate an electrostatic attraction may be used without special limitations. The nano-sized channels as well as the micro-sized channels can be formed through the substantially equal processes. Also, the reversible sealing or the irreversible sealing can be freely selected according to the coating of the curable polymer and UV irradiation time. Therefore, the methods of the present invention are very useful to overcome the limitations of the conventional soft lithography, nanoimprint lithography, and e-beam lithography, which require much cost and complicated processes or has limitation in terms of pattern size.

Nano channels can be formed using substrates formed of various materials, in addition to silicon or quartz substrates. Thus, various kinds of substrates can be used according to purposes. Specifically, in the case of a film substrate, it is possible to form reliable fine channels even if stepped polymer patterns are used.

Also, by using the reversible sealing between the substrate and the polymer, good quality of nano structure having no residual layer can be easily formed. Further, by using a transparent substrate and a biocompatible polymer that can generate the electrostatic attraction, fluorescent analysis of materials is easy in analyzing fluid or bio material. Therefore, the present invention can be widely applied to high-efficiency chips, drug delivery system and DNA separation and analysis using nano fluidics. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1 through 3 are sectional views illustrating a method of forming micro/nano channels according to an embodiment of the present invention.

FIGS. 4 through 8 are sectional views illustrating a method of forming UV curable polymer patterns used for fine channels according to an embodiment of the present invention.

FIGS. 9 through 13 are sectional views illustrating a method of forming UV curable polymer patterns used for fine channels according to another embodiment of the present invention.

FIG. 14 is a sectional view for explaining the channels formed on the stepped polymer patterns.

FIGS. 15 through 20 are sectional views illustrating a method of forming a fine structure according to an embodiment of the present invention.

FIGS. 21 through 26 are sectional views illustrating a method of forming a fine structure according to another embodiment of the present invention.

FIGS. 27 through 32 are SEM photographs of micro channels and nano channels formed using the method of forming the micro/nano channels according to the present invention.

FIGS. 33 through 36 are SEM photographs of linear structures formed using the method of forming the micro/nano structures according to the present invention.

FIGS. 37 through 40 are SEM photographs of structures with nanowell formed using the method of forming the micro/nano structures according to the present invention.

### DETAILED DESCRIPTION OF THE INVENTION

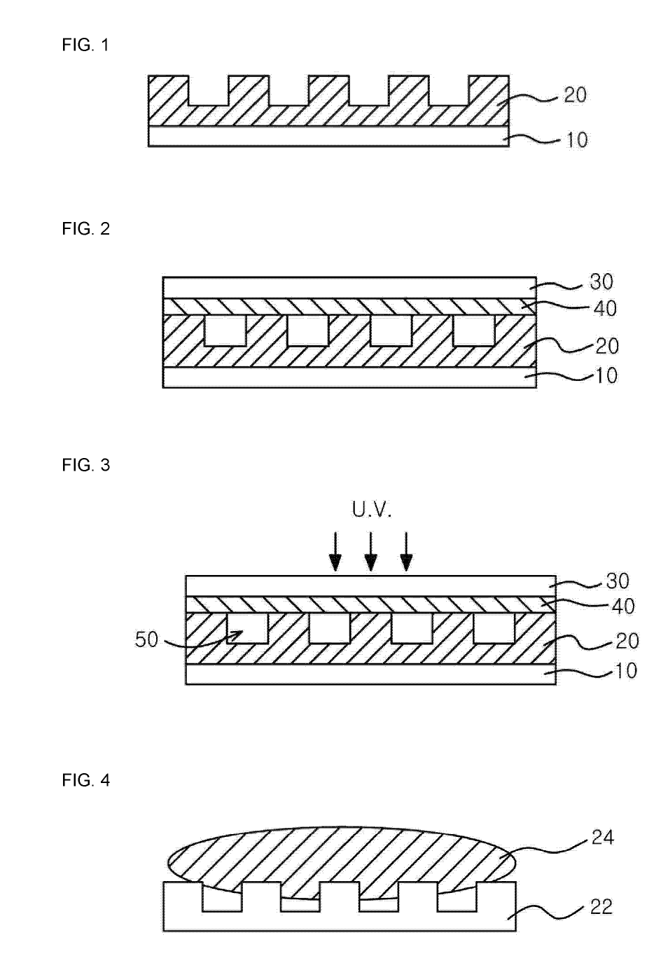

Hereinafter, a method of forming micro/nano channels using an electrostatic attraction and a method of forming a fine structure using the same according to the preferred embodiments of the present invention will be described in detail with reference to the accompanying drawings. First, the present invention provides a method of forming micro/nano channels using polymer that can generate an electrostatic attraction. FIGS. 1 through 3 are sectional views illustrating a method of forming micro/nano channels according to an embodiment of the present invention.

Referring to FIGS. 1 through 3, UV curable polymer patterns 20 are formed on a first substrate 10 (see FIG. 1), and the UV curable polymer patterns 20 contact a second substrate 30 where an UV curable polymer layer 40 is formed (see FIG. 2). Then, UV light is irradiated to irreversibly seal the contact surfaces of the UV curable polymer patterns 20 and the UV curable polymer layer 40, thereby forming channels 50 (see FIG. 3).

This embodiment will now be described in detail step by step.

Referring to FIG. 1, UV curable polymer patterns 20 are formed on a first substrate 10.

If the first substrate 10 is formed of a transparent film such as Poly(Ethylene terephthalate (PET), channels formed using the method of the present invention can be suitably used for analysis of biomolecules. However, the present invention is not limited to this material.

The UV curable polymer patterns 20 may be formed using any material that can generate an electrostatic attraction together with the polymer layer and can be cured by UV irradiation or cross-linked with a contacting structure. Examples of the polymer may include poly ethylene glycol (PEG), poly urethane, poly styrene, and poly methyl methacrylate (PMMA). Specifically, if PEG is used, the channels formed using the method of the present invention can prevent pollution due to biomolecules. In further detail, since it is possible to prevent non-selective adsorption with respect to biomolecules contacting the inner surfaces of the channels, the channels can be used in bio chips.

The UV curable polymer patterns 20 can be formed in various methods.

FIGS. 4 through 8 are sectional views illustrating a method of forming the UV curable polymer patterns 20.

Referring to FIG. 4, a patterned mould 22 is prepared. UV curable polymer 24 flows between patterns of the patterned mould 22 due to the capillary shape, thereby forming UV curable polymer patterns. Therefore, there are no limitations in shapes of the patterns or materials of the mould only if they can induce the capillary flow. For example, in order for forming nano-sized channels, the patterns of the mould 22 must also be nano-sized. Thus, an etching process for forming nano-sized patterns has to be selected. In this case, a silicon substrate patterned by nanoimprint lithography or e-beam lithography may be used.

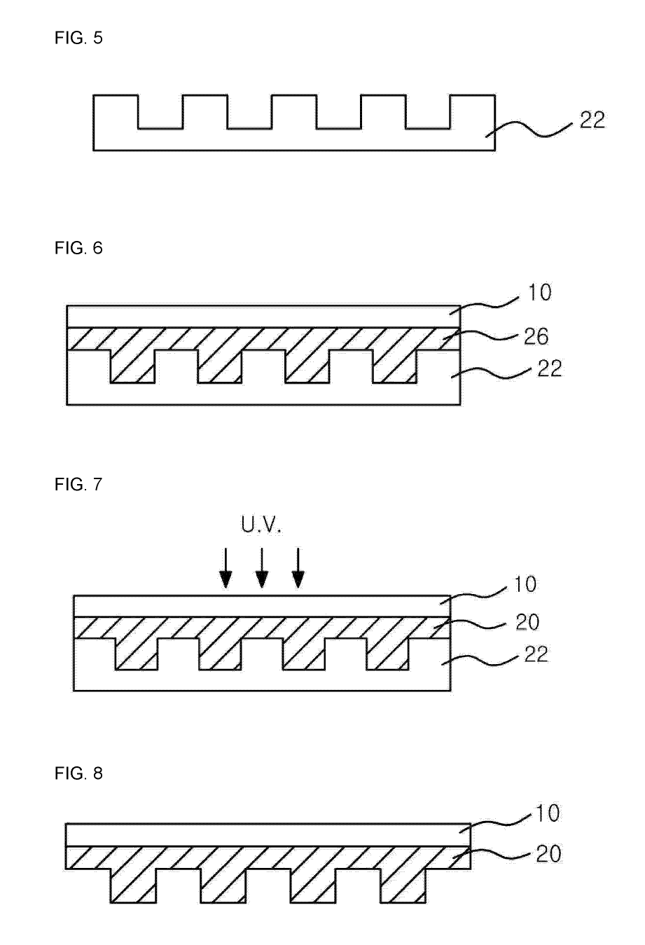

Referring to FIG. 5, the UV curable polymer 24 is coated on the patterned mould 22 by dropping it thereinto. Various materials may be used as the polymer 24 according to purposes of the channels only if the materials can induce an electrostatic attraction and be cured in response to UV light. For example, if the channels of the present invention are used in bio chips or the like, polymer materials such as PEG may be used.

Referring to FIG. 6, the first substrate 10 is covered on and contacted with the coated UV curable polymer 24. Various kinds of substrates can be used as the first substrate 10. The use of a transparent PET film is suitable for a variety of analysis. Also, since the PET film is flexible, the reliable micro/nano channels can be formed even if a structure is stepped. The UV curable polymer 24 dropped into the patterned mould 22 flows due to the capillary phenomenon, thereby forming fine patterns 26. The shape of the fine patterns 26 may be formed before or after the first substrate 10 is covered on the UV curable polymer 24. Referring to FIG. 7, UV curable polymer patterns 20 are formed by irradiating UV light on the fine patterns 26. The UV curable polymer patterns 20 formed in this step must be able to form channels through a cross linkage with a contacting polymer structure by irradiating UV light again in a following step. Therefore, only some of so-called UV activation groups that can be cross-linked due to the UV irradiation in this step are removed and thus incompletely cured. Some of the UV activation groups must remain for a following cross linkage.

Referring to FIG. 8, the substrate 10 having the polymer patterns 20 is formed by removing the patterned mould 22 from the first substrate 10 where the UV curable polymer patterns 20 are formed. The substrate 10 where the polymer patterns are formed will be referred to as a template.

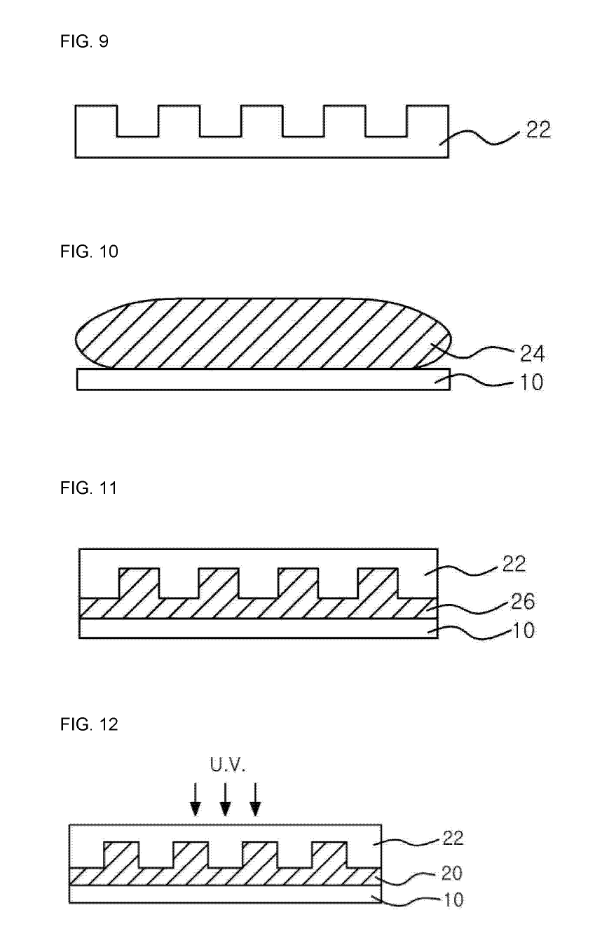

The UV curable polymer patterns 20 can be formed by another methods. FIG. 9 through 13 are sectional views illustrating a method of forming UV curable polymer patterns to be used to form a channel according to another embodiment of the present invention. A description duplicated with that of FIGS. 4 through 8 will be omitted.

Referring to FIG. 9, a patterned mould 22 is prepared. To form nano-sized channels, a silicon substrate patterned by a photo lithography or an e-beam lithography may be used. Referring to FIG. 10, the UV curable polymer 24 is coated on the first substrate 10 using various methods, such as a dropping process or a spin coating process. Various materials may be used as the polymer 24 only if they can generate an electrostatic attraction to induce a reversible sealing with the polymer layer and can be cured in response to UV light. For example, if the channels of the present invention are used in bio chips or the like, polymer materials such as PEG may be used.

Referring to FIG. 11, the patterned mould 22 is stacked on the first substrate to contact with the coated UV curable polymer 24. Because of this stack, the coated UV curable polymer 24 flows into the patterned mould 22 due to the capillary phenomenon and fills an empty space of the patterned mould 22, thereby forming fine patterns 26.

Referring to FIG. 12, UV light is irradiated on the fine patterns 26 to form UV curable polymer patterns 20. It is preferable that the UV irradiation on the fine patterns 26 be performed such that the UV curable polymer patterns 20 can have UV activation groups that can be cross-linked with the UV curable polymer layer 40. The reason for this is that the UV curable polymer patterns 20 formed in this step must be able to form channels through a cross linkage with a contacting polymer structure by irradiating UV light again in a following step.

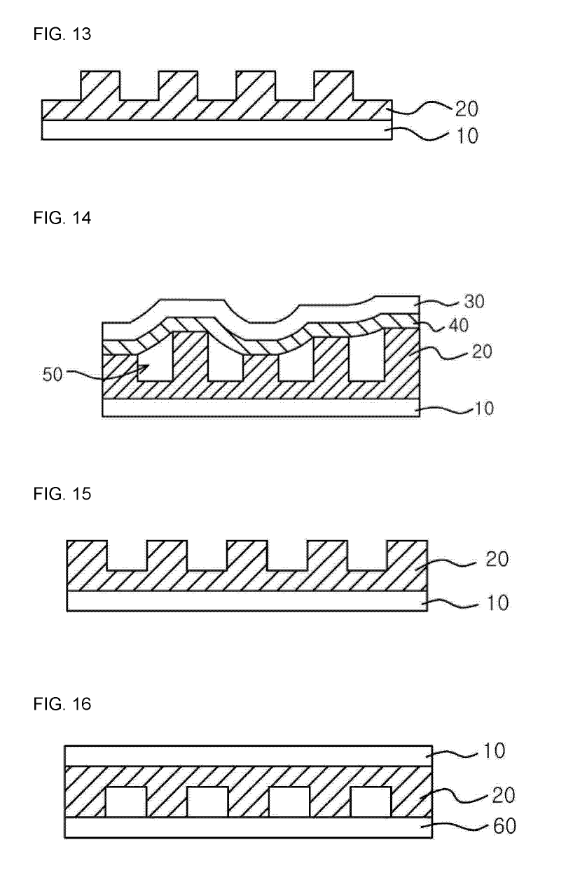

Referring to FIG. 13, the substrate 10 with the polymer patterns 22 is formed by removing the patterned mould 22 from the first substrate 10 where the UV curable polymer patterns 20 are formed.

According to the method of present invention, the UV curable polymer patterns 20 contact a second substrate 30 where the UV curable polymer layer 40 is formed.

Referring to FIG. 2, the bonding between the UV curable polymer patterns 20 and the second substrate 30 where the UV curable polymer layer 40 is formed is achieved by the electrostatic attraction generated by the contact between the UV curable polymer patterns 20 and the UV curable polymer layer 40. Since the conventional soft lithography technology forms a structure such as patterns by inducing a conformal contact of the UV curable polymer patterns 20 and the UV curable polymer layer 40, materials with good wetting properties must be used. Also, it is difficult to form a nano-sized structure in terms of line width.

On the contrary, according to the present invention, any polymer that can induce the electrostatic attraction regardless of wetting properties can be used nano-sized patterns as well as micro-sized patterns can be easily formed according to line width of the mould. Specifically, when the first substrate 10 where the UV curable polymer patterns 20 are formed contacts the polymer layer 40, a negative (−) polarity is induced on the surface of the UV curable polymer patterns 20 and a positive (+) polarity is induced on the opposite surface thereof. Therefore, a conformal contact is formed between the UV curable polymer patterns 20 and the polymer layer 40 due to an instantaneously strong electrostatic attraction.

In this case, it is preferable that a flexible film substrate be used as the first substrate 10 or the second substrate 20 so as to effectively obtain the conformal contact. Such a flexible film substrate includes a PET film. If the cross linkage is performed by the UV irradiation, the conformal contact results in an irreversible sealing. On the contrary, if no UV light is irradiated, a reversible sealing is maintained.

The UV curable polymer layer 40 is formed on the second substrate 30 by spin-coating a UV curable polymer.

Specifically, the UV curable polymer layer 40 is formed by spin-coating the UV curable polymer on the second substrate and irradiating UV light on the spin-coated UV curable polymer.

At this point, in case where a film substrate is used, the UV curable polymer layer 40 and the UV curable polymer patterns 20 can be sealed with a conformal contact even if the UV curable polymer patterns 20 are stepped. Consequently, the reliable channels can be formed. FIG. 4 is a sectional view for explaining the channels formed on the stepped polymer patterns 20. Further, if a transparent PET film is used as the second substrate 30, a fluorometric analysis of materials can be efficiently performed using the channels. In addition, when UV light is irradiated on the spin-coated UV curable polymer, it is necessary to leave some UV activation groups behind. The reason for this is that the irreversible sealing can be achieved in a following process due to the cross linkage with the UV curable polymer patterns 20, which is caused by the UV irradiation.

Referring to FIG. 3, the irreversible sealing is induced by irradiating UV light on the contact surfaces of the UV curable polymer patterns 20 and the UV curable polymer layer 40. Since no UV activation groups remain in the UV curable polymer patterns 20 and the UV curable polymer layer 40, the cross linkage is formed due to the UV irradiation and the irreversible sealing is formed so that it is strong and is difficult to separate. Therefore, it is possible to form micro/nano channels that are formed of polymer alone and have high reliability and good quality.

The present invention provides a method of easily and economically forming a variety of structures, such as micro/nano-sized patterns, using polymer where charges are formed on their surfaces so that an electrostatic attraction can be generated. FIGS. 15 through 20 are sectional views illustrating a method of forming a fine structure according to an embodiment of the present invention.

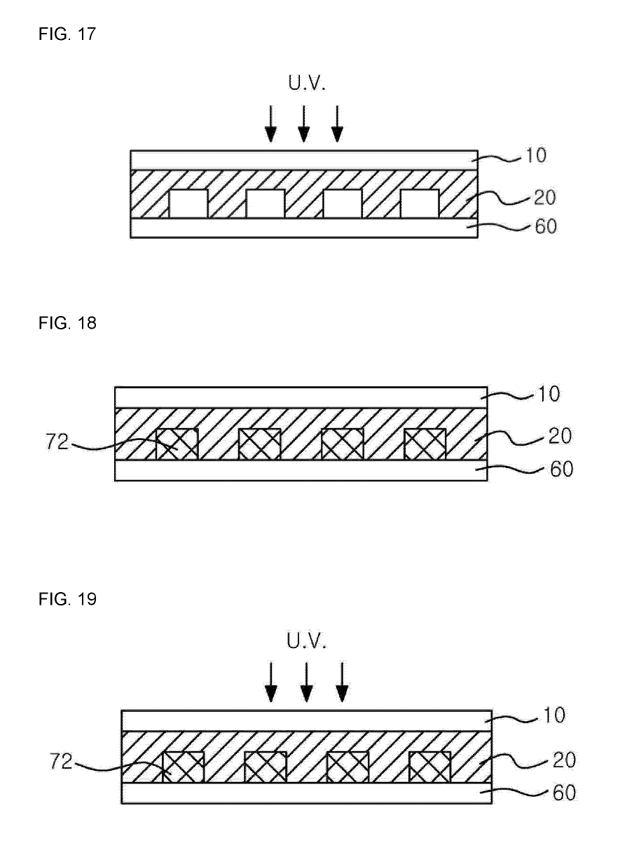

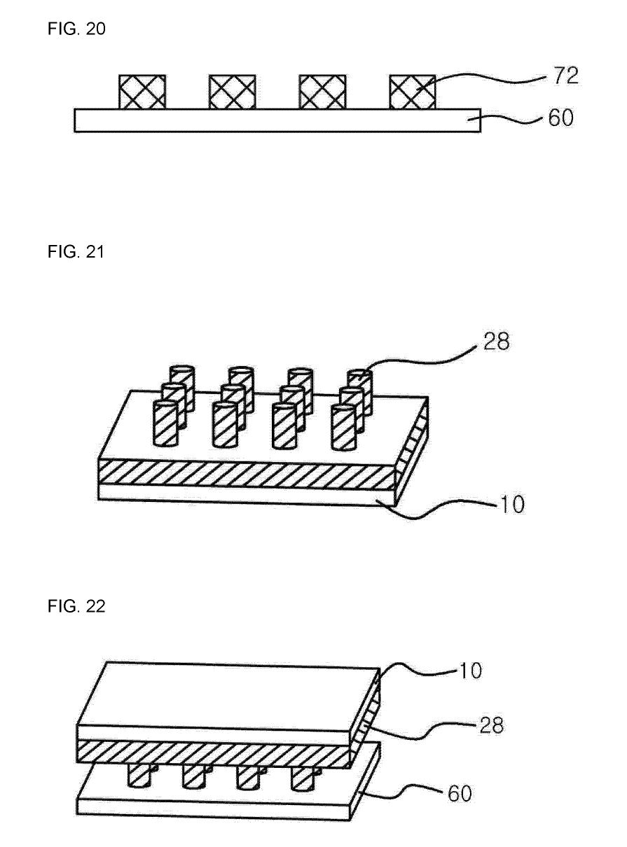

Referring to FIGS. 15 through 20, UV curable polymer patterns 20 are formed on a first substrate 10 (see FIG. 15), and the UV curable polymer patterns 20 and a third substrate 60 are contacted and reversibly sealed together (see FIG. 16). Then, UV light is irradiated on the UV curable polymer patterns 20 reversibly sealed with the third substrate 60 (see FIG. 17), and prepolymer flows into the third substrate 60 to form prepolymer patterns 72 thereon (see FIG. 18). Thereafter, UV light is irradiated to cure the prepolymer patterns 72 (see FIG. 19). Next, the first substrate 10 with the UV curable polymer patterns 20 is removed from the third substrate 60 with the cured prepolymer patterns 72, thereby forming a micro/nano-sized structure (see FIG. 20). This method will now be described in detail step by step with reference to the drawings.

First, referring to FIG. 1, UV curable polymer patterns 20 are formed on a first substrate 10. The UV curable polymer patterns can be formed using the method of FIGS. 4 through 8 or the method of FIGS. 9 through 13. The UV curable polymer patterns can be variously modified considering the shapes of the desired structures. Linear UV curable polymer patterns 20 are illustrated in FIGS. 15 through 20.

Referring to FIG. 16, the UV curable polymer patterns 20 and a third substrate 60 are contacted and reversibly sealed together. As described above, the reversible sealing of the polymer patterns 20 and the third substrate 60 are achieved by an instantaneous electrostatic attraction generated when the polymer patterns 20 and the third substrate 60 are contacted together. To efficiently obtain the reversible sealing, the polymer patterns 20 and the third substrate 60 need to be contacted conformally and entirely. Therefore, it is preferable that a flexible film substrate be used as the third substrate 60 so as to obtain the conformal contact. Also, the third substrate 60 may be formed of various materials (for example, gold (Au), silicon, and glass), which can induce the electrostatic attraction, depending on the purposes of the micro/nano structures. It is preferable that the third substrate 60 be a film substrate. Meanwhile, before the UV curable polymer patterns 20 contact the third substrate 60, an oxygen plasma process may be further performed on the third substrate 60 so as to facilitate the reversible contact between the polymer patterns 20 and the third substrate 60.

Referring to FIG. 17, UV activation groups are removed by irradiating UV light on the UV curable polymer patterns 20 that is reversibly sealed with the third substrate 60. By removing the UV activation groups from the polymer patterns 20, polymerization occurs when UV light will be irradiated on the prepolymer patterns in a following step, thereby preventing the cross linkage. If the irreversible sealing is caused by the cross linkage of the prepolymer patterns 72 and the UV curable polymer patterns 20, it is very difficult to remove the UV curable polymer patterns 20 from the prepolymer patterns 72 without leaving the residual layer behind. Consequently, fine structures with good quality cannot be formed.

Referring to FIG. 18, prepolymer polymer patterns 72 are formed on the third substrate 60 by flowing prepolymer between the third substrate 60 and the UV-irradiated polymer patterns 20. For example, if the prepolymer such as PEG is placed between the third substrate 60 and the polymer patterns 20, which are reversibly sealed to serve as the capillary tube, the prepolymer flows between the third substrate 60 and the polymer patterns 20 due to the capillary phenomenon. Therefore, it is possible to form the prepolymer patterns 72 filling the empty space between the third substrate 60 and the polymer patterns 20. Further, the PEG or the like is a biocompatible material that can prevent non-selective adsorption of biomolecules, and it can be effectively used to form bio chips.

Referring to FIG. 19, UV light is irradiated on the prepolymer patterns 72 to form cured prepolymer patterns 70. At this point, even if the UV light is irradiated, only the prepolymer patterns 72 are cured, while not being linked to the polymer patterns 20, because the cross-linkable UV activation groups have been already removed.

It is preferable that the bonding force between the prepolymer patterns 70 and the third substrate 30 due to the UV irradiation on the prepolymer patterns 72 be greater than that between the third substrate 60 and the UV curable polymer patterns 20 due to the UV irradiation in FIG. 3. Referring to FIG. 20, the first substrate 10 with the UV curable polymer patterns 20 is removed from the third substrate 60 with the cured prepolymer patterns 70, thereby forming the micro/nano structure. In this embodiment, since the linear UV curable polymer patterns 20 are used, the cured prepolymer patterns also become a linear structure. If non-linear UV curable polymer patterns 20 are used, the resulting structures are formed in the respective corresponding shapes. According to another embodiment of the present invention, there is provided a method of forming a fine structure, capable of easily and economically forming a structure with holes (nanowell) partially exposing a substrate by the use of polymer. FIGS. 21 through 26 are sectional views illustrating the method of forming the fine structure according to another embodiment of the present invention. This method is similar to the method of FIGS. 15 through 20, except that a prepolymer structure 78 has holes exposing a third substrate. The duplicated description will be omitted.

Referring to FIGS. 21 through 26, pillar-shaped UV curable polymer patterns 28 are formed on a first substrate 10 (see FIG. 21), and the pillar-shaped UV curable polymer patterns 28 and a third substrate 60 are contacted and reversibly sealed together (see FIG. 22). At this point, the reversible sealing is achieved using an electrostatic attraction.

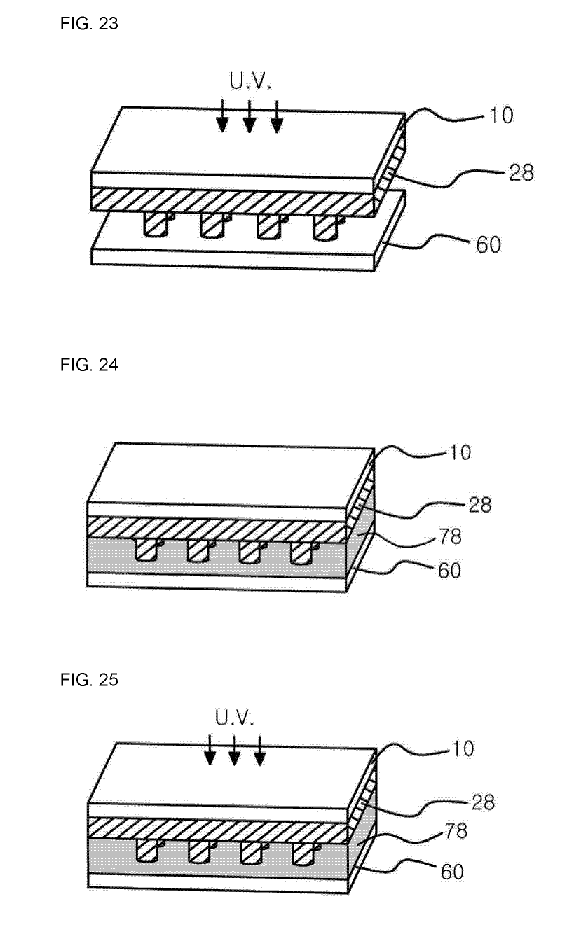

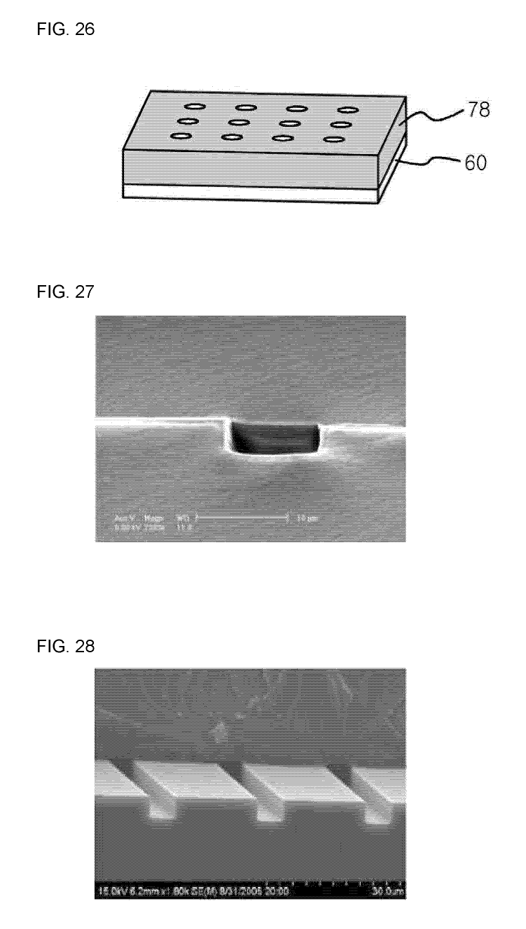

Next, UV light is irradiated on the pillar-shaped UV curable polymer patterns 20 that is reversibly sealed with the third substrate 60 (see FIG. 23). Thereafter, prepolymer flows into the third substrate 60 to form prepolymer patterns 76 with holes exposing the third substrate 60 (see FIG. 24), and UV light is irradiated to cure the prepolymer patterns 76. The first substrate with the UV curable polymer patterns is removed from the third substrate with the cured prepolymer patterns 78, thereby forming the micro/nano structure with holes (so-called nanowell) (see FIG. 26).

Also, various kinds of structures can be easily formed by changing the shapes of the UV curable polymer patterns 20 into various shapes other than the linear or pillar shape. If the structures are used in bio chips, the efficiency in the analysis of biomolecules can be remarkably increased. As described above, if using the polymer that can induce the electrostatic attraction, the structures requiring the reversible or irreversible contact can be easily formed through the basically equal processes by changing only the use of UV irradiation, and so on. Also, if adjusting the pattern size of the mould, micro- and nano-sized patterns can be formed through the equal processes.

The present invention will be understood more fully through the exemplary embodiments. However, the embodiments are merely illustrative but not construed as limiting the present invention.

### Embodiment 1

### Formation of Fine Channels

### 1) Formation of Polymer on First Substrate

A PEG, which is a biocompatible polymer, was dropped and coated on a silicon mould patterned by a photo lithography. A PET film as a first substrate was covered on the coated PEG and was cured by irradiating UV light for about 20 seconds. Then, the silicon mould was removed to form a first substrate with polymer patterns.

2) Contact of Polymer Patterns and Polymer layer

A PET film was prepared as a second substrate. A PEG was coated on the second substrate by a spin coating process. The spin coating was performed at 2000 RPM for about 20 seconds. Then, the second substrate and the coated PEG are sealed together by irradiating UV light for 10 seconds.

### 3) Formation of Irreversible Fine Channels

UV light was irradiated for 3 hours so as to irreversibly seal the PEG polymer layer coated on the second substrate with the PEG polymer patterns formed on the first substrate. Due to the UV irradiation, the cross linkage of the polymer was formed and the micro/nano channels were formed.

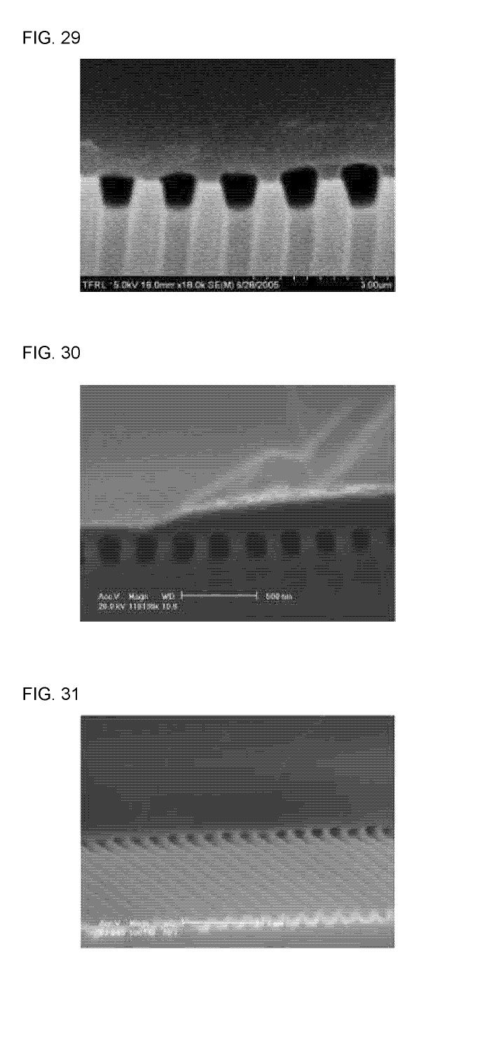

FIGS. 27 and 28 are SEM photographs of the sections of the micro channels formed using the micro-sized mould. It can be seen from FIGS. 28 and 29 that the polymer pattern and the polymer layer form the very high reliable channels.

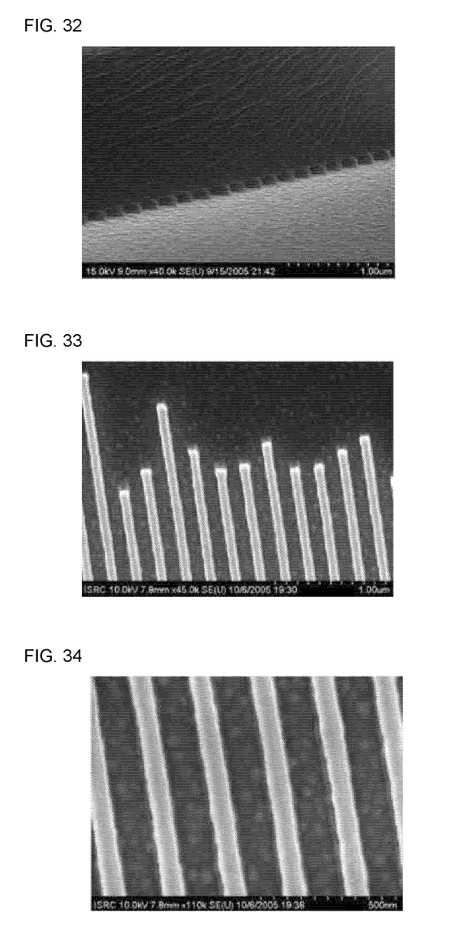

FIGS. 29 and 30 are SEM photographs of the sections of the nano channels formed using the nano-sized mould. FIGS. 31 and 32 are SEM photographs of the partial sections for observing the inner surfaces of the nano channels. It can be seen from FIGS. 29 through 32 that the nano-sized channels that cannot be formed using the conventional soft lithography can be easily formed.

### Embodiment 2

### Formation of Nano-Sized Linear Structure

### 1) Reversible Sealing of Polymer Patterns and Third Substrate

A first substrate (template) was formed. The first substrate includes linear polymer patterns formed using the process 1) of the first embodiment. Then, the polymer patterns and the Au substrate used as a third substrate were conformally contacted together by an electrostatic attraction. At this point, zeta potential of about −113.55 mV was measured at surfaces of the linear polymer patterns formed on the first substrate (template). Thus, a positive (+) polarity was induced on a surface of the Au substrate opposite to the first substrate, and thus the polymer patterns and the Au substrate were reversibly sealed due to the instantaneous electrostatic attraction. Then, UV light was irradiated for about 3 hours to remove the UV activation groups from the polymer patterns. Through these procedures, a line-shaped space serving as the capillary tube was formed between the polymer patterns and the Au substrate.

### 3) Formation of Linear Structure

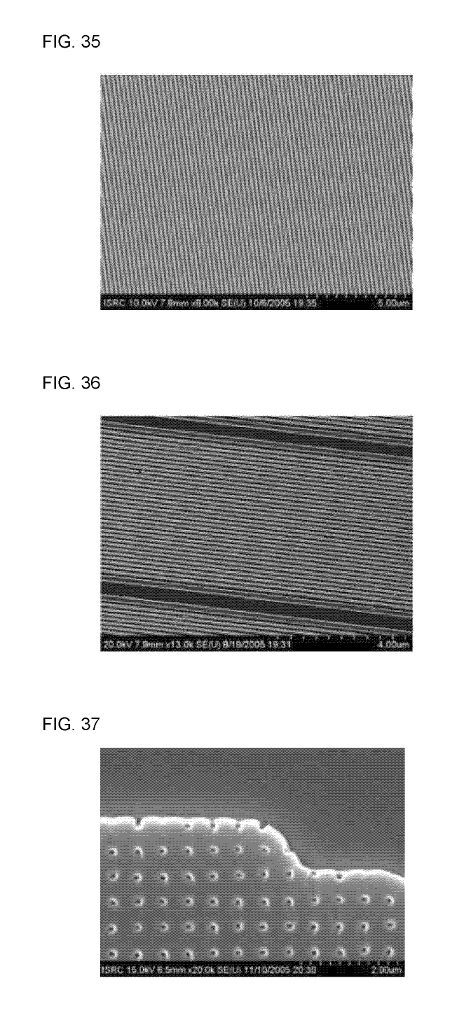

The prepolymer was introduced due to the capillary phenomenon by placing the UV curable prepolymer at an entrance of the capillary tube such that the prepolymer could flow into the capillary tube between the polymer patterns and the Au substrate. FIG. 33 is a SEM photograph of the prepolymer being introduced, and FIG. 34 is a partial enlarged photograph of FIG. 33. Next, UV light was irradiated for about 5 minutes so as to cure the prepolymer introduced into the capillary tube. Then, the template was removed to form the linear structure. FIGS. 35 and 36 are SEM photographs of the linear nano structures formed using the method of forming the nano structure according to the present invention.

### Embodiment 3

### Formation of Nano-Sized Well Structure

1) Reversible Sealing of Polymer Patterns and Third Substrate A first substrate (template) was formed. The first substrate includes polymer patterns having nano-sized pillars. At this point, a silicon mould was patterned to have engraved holes. Then, the polymer patterns with the nano-sized pillars and an Au substrate used as a third substrate were conformally contacted. The polymer patterns and the Au substrate were reversibly sealed due to the instantaneous electrostatic attraction. Then, UV light was irradiated for about 3 hours to remove the UV activation groups from the polymer patterns. Through these procedures, a space between the pillars was formed between the polymer patterns and the Au substrate. The space serves as the capillary tube.

### 2) Formation of Nanowell Structure

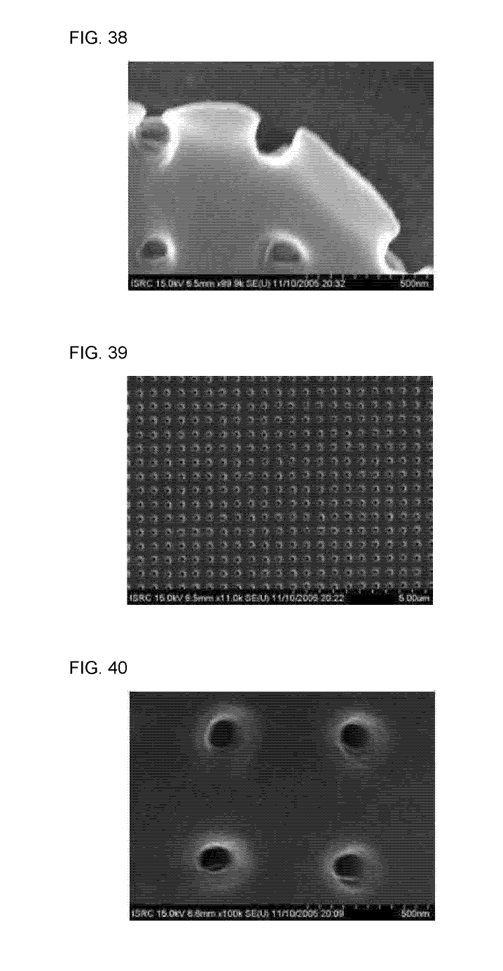

Then, the prepolymer was introduced due to the capillary phenomenon by placing the UV curable prepolymer at an entrance of the capillary tube such that the prepolymer could flow into the capillary tube between the polymer patterns and the Au substrate. FIGS. 37 and 38 are SEM photographs of the sections of the introduced prepolymer at different magnifying power.

UV light was irradiated for about 5 minutes so as to cure the prepolymer introduced into the capillary tube. Then, the template was removed to form polymer patterns with nanowell exposing the third substrate. FIGS. 39 and 40 are SEM photographs of the structures with nanowell according to the present invention.

That is, it can be seen from FIGS. 33 through 36 and 37 through 40 that nano structures can be formed in various shapes through the simple processes.

According to the present invention, any material that can generate an electrostatic attraction may be used without special limitations. The nano-sized channels as well as the micro-sized channels can be formed through the substantially equal processes. Also, the reversible sealing or the irreversible sealing can be freely selected according to the coating of the curable polymer and UV irradiation time. Therefore, the methods of the present invention are very useful to overcome the limitations of the conventional soft lithography, nanoimprint lithography, and e-beam lithography, which require much cost and complicated processes or has limitation in terms of pattern size.

Nano channels can be formed using substrates formed of various materials, in addition to silicon or quartz substrates. Thus, various kinds of substrates can be used according to purposes. Specifically, in the case of a film substrate, it is possible to form reliable fine channels even if stepped polymer patterns are used.

Also, if using the reversible sealing between the substrate and the polymer, good quality of nano structure having no residual layer can be easily formed. Further, Moreover, if using a transparent substrate and a biocompatible polymer that can generate the electrostatic attraction, fluorometric analysis of materials is easy in analyzing fluid or bio material. Therefore, the present invention can be widely applied to high-efficiency chips, drug delivery system and DNA separation and analysis using nano fluidics.

What is claimed is:

1. A method of forming a fine channel, comprising:
forming UV curable polymer patterns on a first substrate;
sealing the UV curable polymer patterns and a second substrate by an electrostatic attraction, the second substrate including a UV curable polymer layer formed thereon; and
forming a channel by irradiating UV light such that UV curable polymer patterns and the UV curable polymer layer sealed together are cross-linked by polymerization.

2. The method of claim 1, wherein the UV curable polymer patterns and the UV curable polymer layer include polymer allowing induction of the electrostatic attraction.

3. The method of claim 1, wherein the UV curable polymer patterns and the UV curable polymer layer are selected from the group consisting of poly ethylene glycol (PEG), poly urethane, poly styrene, and poly methyl methacrylate (PMMA).

4. The method of claim 1, wherein the first substrate and the second substrate are Poly(Ethylene Terephthalate (PET) film.

5. The method of claim 1, wherein forming of the UV curable polymer patterns comprises:
preparing a patterned mould;
dropping and coating UV curable polymer on the patterned mould;
stacking the first substrate on the coated UV curable polymer;
forming a fine pattern by flowing the coated UV curable polymer due to capillary phenomenon;
irradiating UV light on the fine pattern to form UV curable polymer patterns; and
removing the patterned mould from the first substrate in which the UV polymer patterns are formed.

6. The method of claim 5, wherein the UV light is irradiated on the fine pattern such that UV activation groups cross-linkable with the UV curable polymer layer remain in the UV curable polymer patterns.

7. The method of claim 1, wherein the forming of the UV curable polymer patterns comprises:
preparing a patterned mould;
coating the UV curable polymer on the first substrate;
stacking the patterned mould on the first substrate such that the patterned mould contacts the coated UV curable polymer;
forming a fine pattern by flowing the coated UV curable polymer due to capillary phenomenon;
irradiating UV light on the fine pattern to form UV curable polymer patterns; and
removing the patterned mould from the first substrate in which the UV curable polymer patterns are formed.

8. The method of claim 1, wherein the forming of the UV curable polymer layer comprises:
spin-coating UV curable polymer on the second substrate; and
irradiating UV light on the spin-coated UV curable polymer to form the UV curable polymer layer.

9. The method of claim 8, wherein the UV light is irradiated on the spin-coated UV curable polymer such that UV activation groups cross-linkable with the UV curable polymer patterns remain in the UV curable polymer layer.

10. A method of forming a fine structure, comprising:
forming UV curable polymer patterns on a first substrate;
contacting the UV curable polymer patterns and a third substrate to reversibly seal the UV curable polymer patterns and the third substrate by an electrostatic attraction;
irradiating UV light on the UV curable polymer patterns reversibly sealed with the third substrate;
forming prepolymer patterns on the third substrate by flowing prepolymer between the third substrate and the polymer patterns to which the UV light is irradiated;
curing the prepolymer patterns by irradiating UV light thereon; and
removing the first substrate with the UV curable polymer patterns from the third substrate with the cured prepolymer patterns.

11. The method of claim 10, wherein the UV curable polymer patterns are a linear pattern, and the prepolymer patterns are a linear structure formed on the third substrate.

12. The method of claim 10, wherein the UV curable polymer patterns is a pillar-shaped pattern, and the prepolymer patterns are a structure with holes partially exposing the third substrate.

13. The method of claim 10, wherein the third substrate is a film substrate that is conformally contactable with the UV curable polymer patterns due to an electrostatic attraction.

14. The method of claim 10, wherein the third substrate includes gold (Au), silicon, or glass.

15. The method of claim 10, further comprising performing a plasma process on the third substrate so as to facilitate the reversible contact between the polymer patterns and the third substrate.

16. The method of claim 10, wherein UV activation groups cross-linkable with the prepolymer patterns are removed from the UV curable polymer patterns due to the UV irradiation on the UV curable polymer patterns.

17. The method of claim 10, wherein a bonding force between the prepolymer patterns and the third substrate due to the UV irradiation on the prepolymer patterns is greater than that between the third substrate and the UV curable polymer patterns due to the UV irradiation on the UV curable polymer patterns reversibly sealed with the third substrate.
